(19) United States
(12) Patent Application Publication
(10) Pub. No.: US 2024/0157773 A1
(43) Pub. Date: May 16, 2024

(54) CONVERTIBLE ARRANGEMENT HAVING A CONVERTIBLE TOP AND/OR A CONVERTIBLE TOP BOX LID

(71) Applicant: Webasto SE, Stockdorf (DE)

(72) Inventors: Magnus SVIBERG, Stockdorf (DE); Franz HABERL, Stockdorf (DE); Alexander HAIMERL, Stockdorf (DE); Robert ELEK, Stockdorf (DE); Heinrich WÜLLRICH, Stockdorf (DE); Richard SEIDL, Stockdorf (DE)

(21) Appl. No.: 18/503,362

(22) Filed: Nov. 7, 2023

(30) Foreign Application Priority Data
Nov. 10, 2022 (DE) 10 2022 129 781.0

(51) Int. Cl. B60J 7/12; B60J 1/00

(52) U.S. Cl. CPC B60J 7/1204; B60J 1/003; B60J 7/1239

(57) ABSTRACT

A convertible arrangement having a displaceable top is displaceable between a covering position, in which it spans a vehicle interior, and a storage position, in which the vehicle interior is exposed at the top and the convertible top is received by a convertible top storage space. An environment sensor and/or an environment sensor accessory are/is disposed at the convertible top.

### CROSS-REFERENCE TO RELATED APPLICATION

This application claims priority from German Patent Application Number 10 2022 129 781.0, filed on Nov. 10, 2022, which is hereby incorporated herein by reference in its entirety.

### FIELD

The invention relates to a convertible arrangement having the features of the preamble of claim 1 and to a convertible arrangement having the features of the preamble of claim 6.

### BACKGROUND

Convertible arrangements of this kind are known from practice and constitute part of a convertible vehicle. The convertible arrangements each comprise a displaceable convertible top, which is displaceable between a covering position spanning a vehicle interior from the top and a storage position exposing the vehicle interior at top. In the storage position, the convertible top is received by a rearward storage space of the corresponding convertible vehicle. Depending on the vehicle type, the storage space is always open or provided with a pivotable convertible top box lid, whose rest position is a closing position closing the storage space from the top. In order to be able to displace the convertible top between the storage position and the covering position, i.e., being able to retract or extract the convertible top from or into the storage space, the convertible top box lid is displaceable from its closed position to an open position exposing the vehicle interior at the top.

Furthermore, document DE 10 2019 122 193 B4, for example, discloses a roof module of a motor vehicle, which is provided with environment sensors which enable autonomously driving the motor vehicle provided with the roof module. The environment sensors, which are designed in particular as lidar sensors, chart the vehicle environment and transmit corresponding measuring signals to a control system, which interacts with a vehicle control and/or a vehicle drive. The roof module is rigidly fixed to the vehicle structure.

### SUMMARY

The object of the invention is to create a convertible arrangement which provides means to a convertible vehicle for being operated in an autonomous or semi-autonomous vehicle operation.

According to the invention, this object is attained by the convertible arrangement having the features of claim 1 and by the convertible arrangement having the features of claim 6.

According to a first aspect of the invention, a convertible arrangement is therefore proposed, which comprises a displaceable convertible top which is displaceable between a covering position, in which it spans a vehicle interior, and a storage position, in which the vehicle interior is exposed at the top and the convertible top is received by a convertible top storage space. In order to be able to use the convertible arrangement for an autonomous and/or semi-autonomous operation of the corresponding convertible vehicle, an environment sensor and/or an environment sensor accessory are/is disposed on the convertible top. The environment sensor and/or the environment sensor accessory is consequently integrated such in the convertible arrangement that it becomes displaced relative to the vehicle structure of the corresponding convertible vehicle when the convertible top is displaced. Upon displacement of the convertible top, the environment sensor and/or the environment sensor accessory are/is preferably dislocated such that the environment sensor and/or the environment sensor accessory are/is still available and/or its use for autonomous and/or semi-autonomous driving the corresponding vehicle is still possible. The environment sensor and/or the environment sensor accessory are/is therefore disposed in such a manner on a component of the corresponding convertible top that the sensor technology can be used for charting the vehicle environment in both the covering position of the convertible top and in the storage position of the convertible top.

In a preferred embodiment of the convertible arrangement according to the invention, the convertible top comprises a front bow, at the upper side of which the environment sensor is disposed. In the covering position of the convertible top, i.e., when the roof is closed, the environment sensor is disposed close to a front header of the corresponding vehicle owing to its arrangement on the front bow, whereas it is dislocated towards the convertible top storage space when in the storage position and can chart the vehicle environment from the corresponding position. The front bow, which is typically designed as a rigid component and can be a front roof shell of an RHT, forms a stable mounting platform for the environment sensor.

In a special embodiment of the convertible arrangement according to the invention, the front bow, at the upper side of which the environment sensor is disposed, forms at least part of a convertible top box lid, which closes the convertible top storage space in the storage position of the convertible top. The environment sensor disposed on the front bow can chart the vehicle environment when in the covering position both towards the front and the rear, whereas it preferably only detects the vehicle environment towards the rear in the storage position. The vehicle environment can be detected towards the front by other environment sensors provided on the vehicle structure when the convertible top is in the storage position. The corresponding control is carried out via a controller of the corresponding convertible vehicle.

In another special embodiment of the convertible arrangement according to the invention, the convertible top comprises a lowerable rear bow, at which the environment sensor is disposed. The rear bow forms, for example, a convertible top box which forms a rear edge corner area in the covering position of the convertible top and receives a drive for a folding top section of the convertible top, the folding top section spanning the vehicle interior of the convertible top at the top. The folding top area can be displaced at the convertible top box and be dislocated between the storage position received in the convertible top storage space and a lifted position together with the convertible top box by means of suitable kinematics.

As can be derived from the embodiments described above, the environment sensor of the convertible arrangement according to the invention has at least one field of view, which changes as a function of the position of the convertible top, as the position of the environment sensor changes in relation to the vehicle structure with the covering position.

The subject matter of the invention according to a second aspect is a convertible arrangement which comprises a displaceable convertible top which is displaceable between a covering position, in which it spans a vehicle interior, and a storage position, in which the vehicle interior is exposed at the top and the convertible top is received by a convertible top storage space and a convertible top box lid, which is displaceable between a closed position closing the convertible top storage space and an open position exposing the convertible top storage space at the top. In order to be able to use the convertible arrangement for the purpose of autonomous and/or semi-autonomous driving, at least one environment sensor and/or at least one environment sensor accessory are/is disposed at the convertible top box lid. The environment sensor and/or the environment sensor accessory are/is therefore disposed at a movable part of the convertible arrangement, meaning also being moved upon displacement of the convertible top box lid, an integration in a visually appealing manner being possible.

The convertible top box lid is in particular what is known as a tonneau cover and can also form a back shelf in one area, if required, the back shelf being located in the vehicle interior spanned by the convertible top in the covering position of the convertible top and being disposed to the rear of a seat of the vehicle structure.

In a functional embodiment of this convertible arrangement, the environment sensor has a field of view oriented towards the vehicle rear when in the closed position of the convertible top box lid. By means of the environment sensor integrated in the convertible top box lid, the vehicle environment to the rear of the corresponding convertible vehicle can consequently be monitored.

The environment sensor can be disposed such at the convertible top box lid that its sensor see-through area is exposed when the convertible top is in the storage position and the convertible top box lid is spanned by the convertible top when the convertible top is in the covering position. In order to be able to use the environment sensor for monitoring and charting the vehicle environment in this instance as well, the convertible top has a rear window which is disposed such that it is located in the field of view of the environment sensor and consequently forms an additional sensor see-through area. The field of view of the environment sensor thus does not depend on whether the convertible top takes up its covering position or its storage position. In this embodiment, the environment sensor is preferably integrated in a dome and/or what is known as a power scoop, which is formed at the convertible top box lid. Thus it is ensured that the environment sensor is disposed at a height sufficient for charting a suitable area of the vehicle environment without being in the shade of the vehicle structure.

In an alternative embodiment of the convertible arrangement according to the invention, in which a deploying bracket of the convertible top designed as a folding top or rests on the convertible top box lid when in its covering position or a roof shell of the convertible top designed as a folding roof rests on the convertible top box lid when in its covering position, a sensor see-through area, which borders on the vehicle environment independently of the covering position, is formed at the convertible top box lid, i.e., is exposed. The convertible top does not need to form any additional sensor see-through areas via which the environment sensor can monitor the vehicle interior when the convertible top is in in the covering position. Indeed, a sensor see-through area can be formed merely on a step or a different elevation of the convertible top box lid.

The convertible top of the convertible arrangement according to the invention can be and/or comprise a folding roof, an RHT (retractable hard top), panel bow convertible top or the like.

The environment sensor, with which the convertible top or the convertible top box lid of the convertible arrangements according to invention is provided, can be designed in various manner and comprise in particular a lidar sensor, a radar sensor, an optical sensor, such as a camera, and/or the like. A lidar sensor preferably functions in a wavelength range of approximately 905 nm or of approximately 1,550 nm. A camera used as an environment sensor can operate in the wavelength range of visible light and/or in the infrared range.

In the present case, the term environment sensor accessory element is to be understood in all its facets, meaning it comprises elements which in particular ensure the availability and the safe operation of the environment sensor and comprise heaters, coolers, cleaners, de-icers, air conditioners and/or the like, for example. It is to be understood that the environment sensor and the environment sensor accessory are adapted to be part of an autonomous driving system of the vehicle in question and may be connected to a controller of the autonomous driving system. Thus, preferably, the environment sensor can monitor the vehicle environment in order to determine traffic situations, on basis of which the controller can control the driving behavior of the vehicle.

Further advantages and advantageous embodiments of the subject matter of the invention can be derived from the description, the drawing and the claims.

### BRIEF DESCRIPTIONS OF THE DRAWINGS

Exemplary embodiments of convertible arrangements according to the invention are shown in a schematically simplified manner in the drawing and are described in more detail in the following description.

FIG. 1 shows a convertible vehicle having a convertible arrangement, whose convertible top takes up a covering position;

FIG. 2 shows a view of a convertible vehicle corresponding to FIG. 1, wherein, however, its convertible top is in the storage position;

FIG. 3 shows a schematic longitudinal cut through a rear section of the convertible arrangement when the convertible top is in the closed position;

FIG. 4 shows a view according to FIG. 3, wherein, however, the convertible top is in the storage position;

FIG. 5 shows a longitudinal cut through an alternative embodiment of a convertible arrangement according to the invention in its rear section having a convertible to pin its covering position;

FIG. 6 shows a longitudinal cut of the convertible arrangement according to FIG. 5, wherein, however its convertible top is in the storage position;

FIG. 7 shows a lateral view of a convertible vehicle having a front bow, which has an environment sensor, when the convertible top is in the covering position;

FIG. 8 shows a lateral view of the convertible vehicle according to FIG. 7, wherein, however, its convertible top is in the storage position;

FIG. 9 shows a lateral view of an alternative embodiment of a convertible arrangement when the convertible top is in the covering position; and

FIG. 10 shows a lateral view of the convertible arrangement according to FIG. 9, wherein, however, its convertible top is in the storage position.

### DETAILED DESCRIPTION

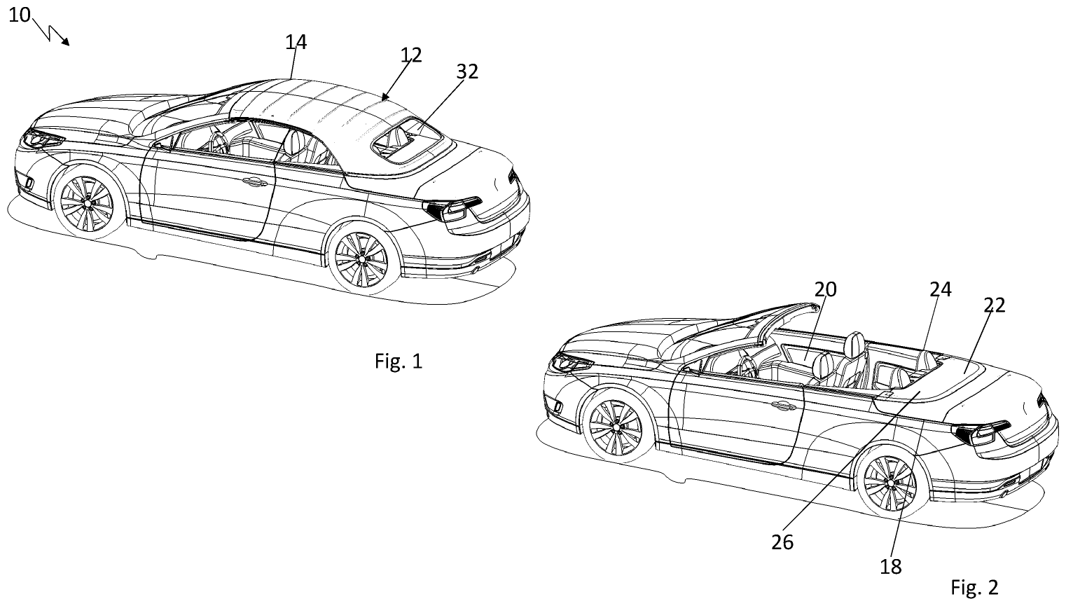

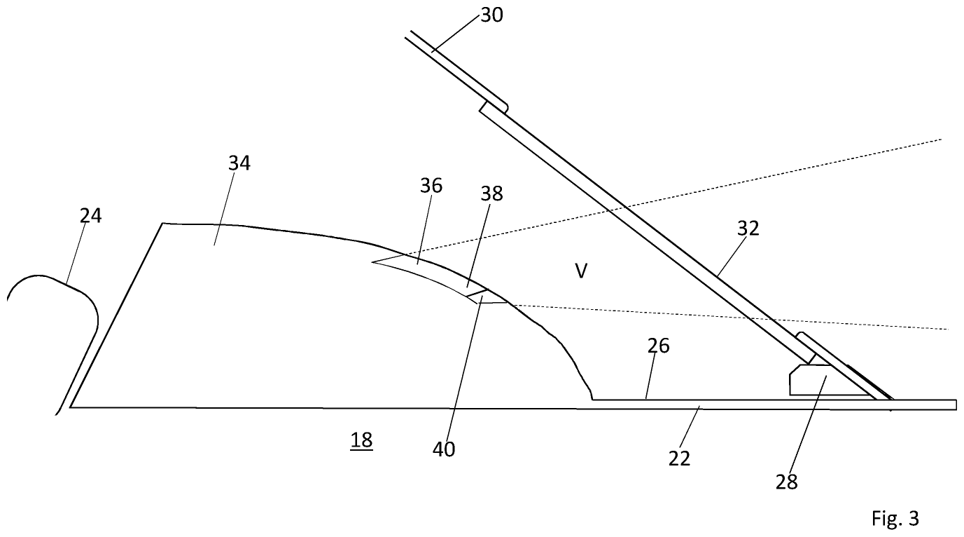

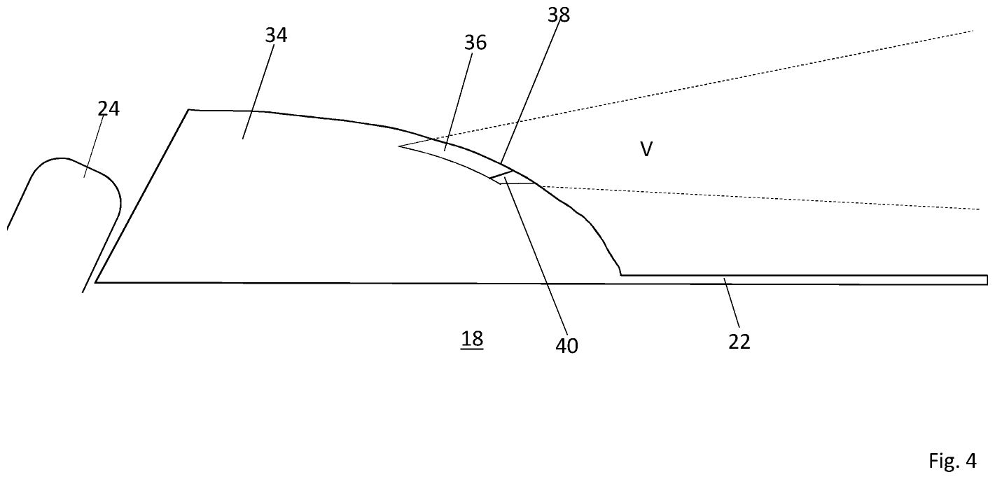

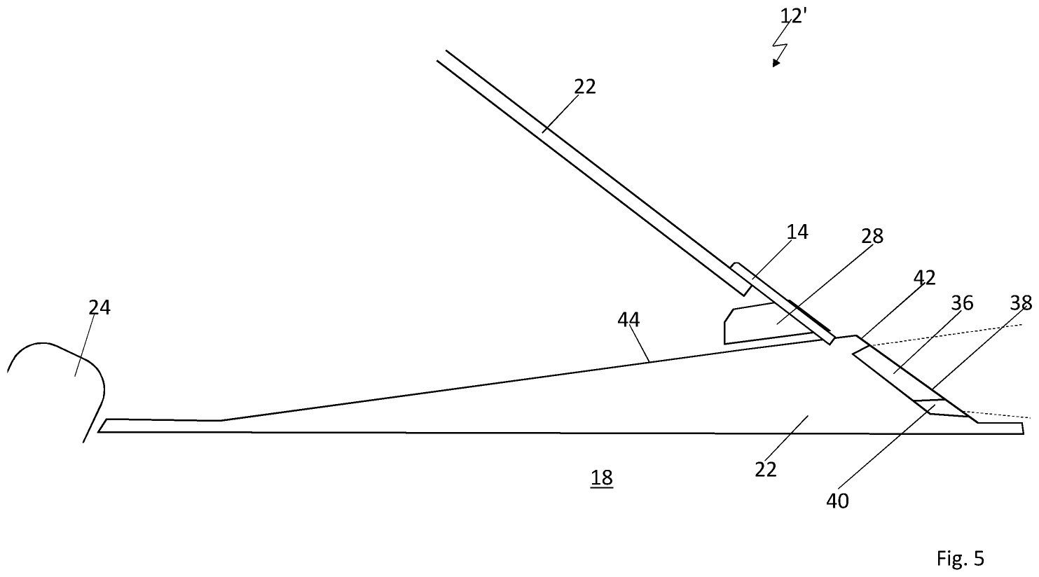

FIGS. 1 to 4 show a convertible vehicle 10 having a convertible arrangement 12, which is equipped with a convertible top 14 designed as a folding roof and a convertible storage space 18, which is disposed to the rear of a vehicle interior 20. Convertible top 14 is displaceable between a covering and/or closing position, which is shown in FIGS. 1 and 3 and in which vehicle interior 20 is spanned by convertible top 14, and a storage position, in which it is received by convertible top storage space 18 and vehicle interior 20 is open towards the top (compare FIGS. 2 and 4).

In order to grant convertible vehicle 10 a visually appealing appearance, in particular in the storage position of convertible top 14, convertible top storage space 18 is provided with a convertible top box lid 22, which is what is known as a tonneau cover and is displaceable between a shown closed position, in which convertible top storage space 18 is closed towards the top, and an open position (not shown), in which convertible top storage space 18 is exposed at the top, meaning convertible top 14 can either be stored in convertible top storage space 18 or be extracted from convertible top storage space 18 to take up the covering position.

Convertible top box lid 22 forms a back shelf area 26 to the rear of a backseat 24, back shelf area 26 being enclosed by a rear deploying bracket 28 of convertible top rods (not shown) when the convertible top is in the covering position, convertible top 14 being displaceable and/or a convertible top cover 30, which forms an outer shell of convertible top 14 when in the covering position, being able to be opened upon actuation of the convertible top rods.

With respect to the covering position shown in FIGS. 1 and 3, convertible top 14 has a rear window 32, which is located in a rear area, is inserted in a corresponding opening of convertible top cover 30 and is disposed higher than deploying bracket 28 in the covering position.

Back shelf area 26 of convertible top box lid 22 has a dome 34, which is realized as an elevation and in which an environment sensor 36 is disposed which serves for monitoring a vehicle environment in the rear area of convertible vehicle 10 and which is provided with a sensor see-through area 38 formed flush at dome 34. Via environment sensor 36 and sensor see-through area 38, a field of view V of environment sensor 36 is defined, which is aligned towards the vehicle rear when convertible top box lid 22 is in the closed position. Environment sensor 36 is configured as a lidar sensor, but can also comprise a radar sensor, a camera and/or the like.

As in particular FIG. 3 shows, field of view V of environment sensor 36 passes through rear window 32, which therefore forms an additional sensor see-through area, when convertible top 14 is in the closed position. In contrast, sensor see-through area 38, which is formed at dome 34, is exposed at the vehicle exterior when convertible top 14 is in the storage position. Field of view V remains unaffected by this.

Furthermore, a cooling and/or heating device 40, which keeps environment sensor 36 at a suitable operating temperature, is disposed at dome 34 of convertible top box lid 22.

Environment sensor 36 is a component of a sensor technology of convertible vehicle 10, the sensor technology being connected to a controller enabling autonomously driving convertible vehicle 10.

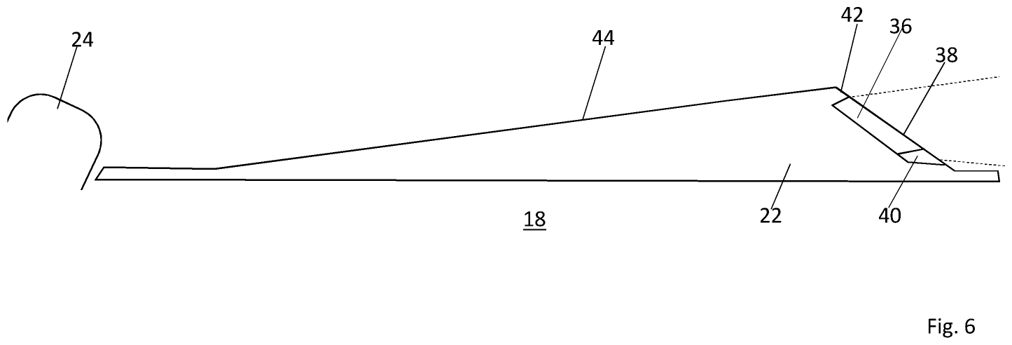

In FIGS. 5 and 6, an alternative embodiment of a convertible arrangement, which mostly coincides with the embodiment according to FIGS. 1 to 4, but differs in the respect that it has a convertible top box lid 22 which is at least approximately wedge-shaped in its longitudinal cut and has an outer surface 42, which can be deemed a step surface and in whose area an environment sensor 36 having a see-through area 38 and a cooling and/or heating device 40 are disposed, cooling and/or heating device 40 being an environment sensor accessory which keeps environment sensor 36 at a desired operating temperature. A deploying bracket 28 of convertible top rods of convertible 14 of convertible arrangement 12′ rests in such a manner on an upper wedge surface 44 of convertible top box lid 22 when convertible top 14 is in the covering position that it is disposed above environment sensor 36 and a field of view V of environment sensor 36 is not shaded by deploying bracket 28. When convertible top 14 is in the storage position, convertible top 14 together with deploying bracket 28 is received by convertible top storage space 18 disposed below convertible top box lid 22. Sensor see-through area 28 of environment sensor 36 borders directly on the vehicle environment independently of the position of convertible top 14 and deploying bracket 28.

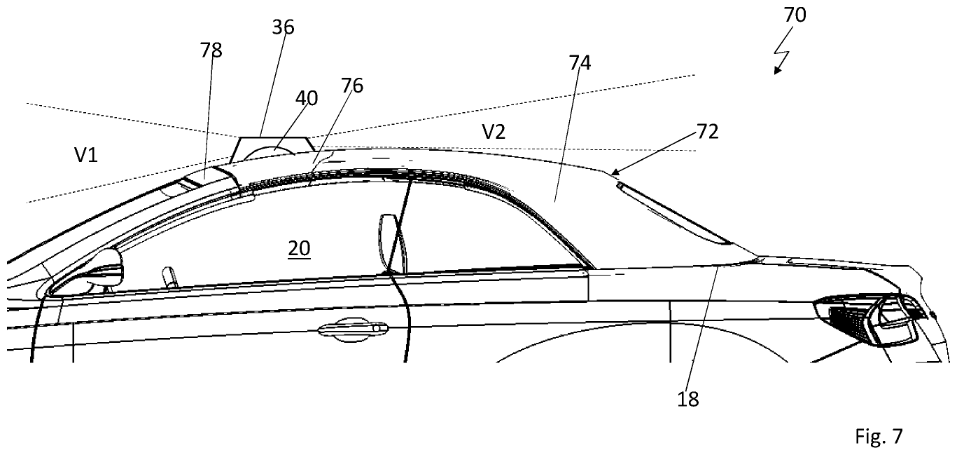

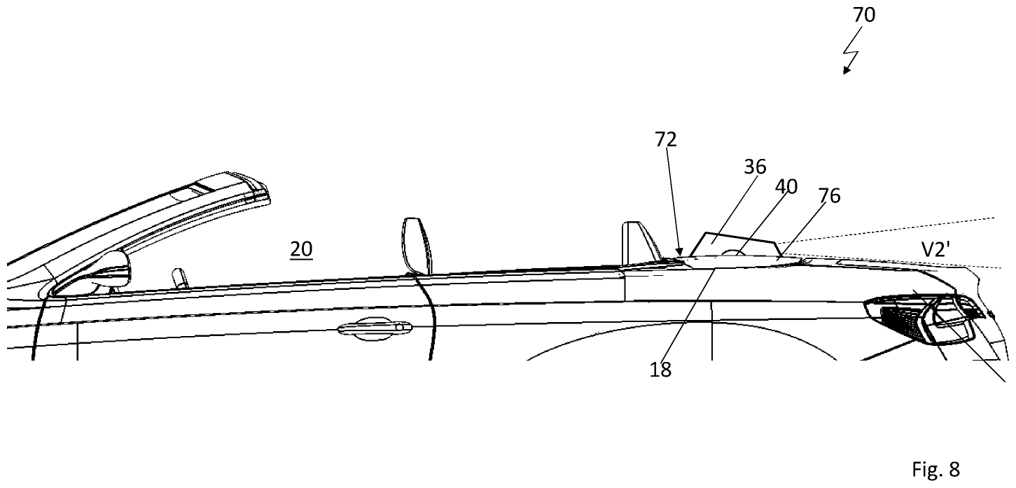

FIGS. 7 and 8 show a convertible vehicle 70, which is provided with a convertible arrangement 72 having a convertible top realized as a folding roof. Convertible top 74 is displaceable between a covering position shown in FIG. 7 and spanning a vehicle interior 20 and a storage position, which exposes vehicle interior 20 at the top and in which convertible top 74 is essentially received by a rear convertible top storage space of convertible vehicle 10 (compare FIG. 8). Convertible top 74 has a front bow 76, which borders on a front roof header 78 of convertible vehicle 10 at the front when convertible top 14 is in the covering position, front roof header 78 forming an upper frame element of a windshield extending in the transverse vehicle direction. In the storage position, front bow 76 forms a convertible top box lid, which closes the top of the front convertible top storage space 18 of convertible arrangement 72.

Front bow 76 has an environment sensor 36 at its upper side, environment sensor 36 being designed as a lidar sensor and has a field of view V1 directed towards the vehicle rear and a field of view V2 directed towards the vehicle front. In addition, cooling and/or heating devices 40 are formed at front bow 76, cooling and/or heating devices 40 serving for conditioning and/or controlling the temperature of environment sensor 36, thus ensuring its disruption-free operation.

As FIGS. 7 and 8 show, environment sensor 36 is moved along with front bow 76 when displacing the convertible top between the covering position and the storage position, meaning it is disposed to the rear of vehicle interior 20 when in the covering position. In the covering position, environment sensor 36 can only chart the vehicle environment in the rear area of the vehicle, meaning field of view V1 oriented towards the front is turned off. The vehicle environment is detected rearward using a field of view V2′ changed owing to the changed position of environment sensor 36 with respect to the covering position shown in FIG. 7.

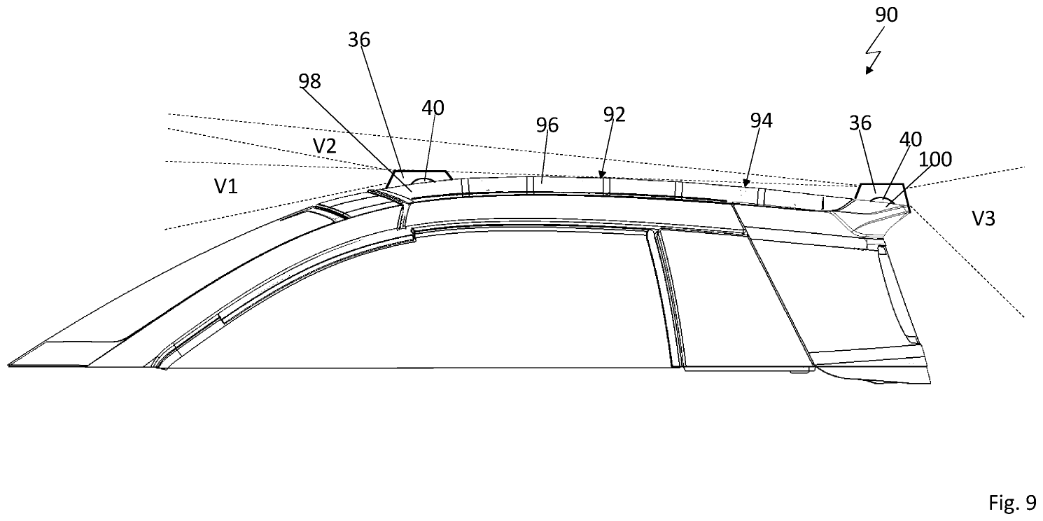

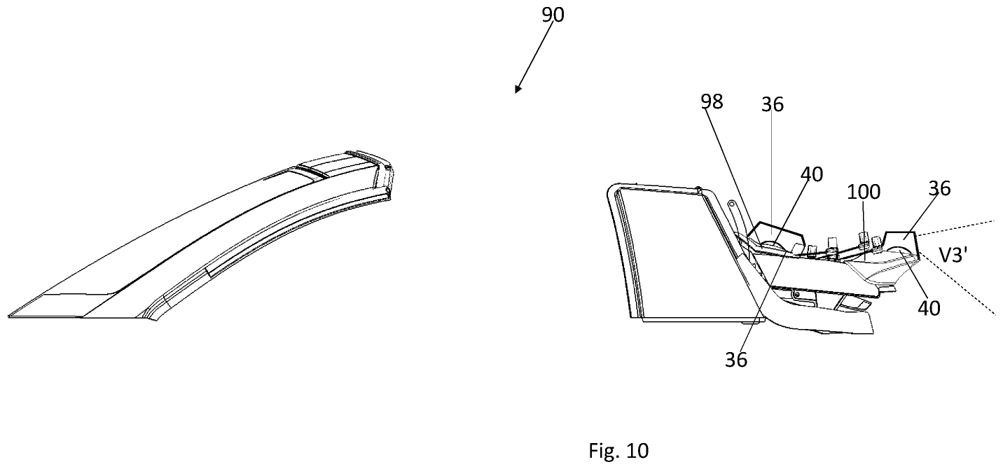

FIGS. 9 and 10 show a convertible vehicle 90 provided with a convertible arrangement 92 having a convertible top 94, which has a folding-roof section 96 having a front bow 98 and a rear and/or corner bow 100, which forms a convertible top box, which receives actuation means for folding-roof section 96. Corner bow 100 is mounted on a vehicle structure of convertible vehicle 90 via suitable kinematics and can be displaced between the lifted position shown in FIG. 9 and the storage position, which is shown in FIG. 10 and in which folding-roof section 96 is moved against corner bow 100.

Front bow 98 is provided with an environment sensor 36 and a cooling and/or heating device 40 for environment sensor 36 at its upper side. At corner bow 100, another environment sensor 36 and a cooling and/or heating device 40 are disposed on the upper side. Environment sensor 36 of front bow 98 and corner bow 100 each have a field of view V1 and V2, respectively, oriented towards the vehicle front when in the covering position shown in FIG. 9. Environment sensor 36 of corner bow 100 further has a field of view V3, which is oriented towards the rear and charts the environment of convertible vehicle 90 to the rear.

In the covering position of convertible top 94 as shown in FIG. 10, fields of view V1 and V2, which are oriented towards the front, are deactivated. Merely environment sensor 36 formed at corner bow 100 remains active for charting the vehicle environment to the rear of convertible vehicle 90, namely using a modified field of view V3′, which differs from field of view V3 of the covering position owing to the changed position of environment sensor 36 in relation of the vehicle structure.

1. A convertible arrangement, comprising:
a displaceable convertible top which is displaceable between a covering position, in which it spans a vehicle interior, and a storage position, in which the vehicle interior is exposed at the top and the convertible top is received by a convertible top storage space,
wherein an environment sensor and/or an environment sensor accessory are/is disposed at the convertible top.

2. The convertible arrangement according to claim 1, wherein the convertible top comprises a front bow, at the upper side of which the environment sensor is disposed.

3. The convertible arrangement according to claim 2, wherein the front bow forms at least part of a convertible top box lid, which closes the convertible top storage space in the storage position of the convertible top.

4. The convertible arrangement according to claim 1, wherein the convertible top comprises a lowerable bow, at which the environment sensor is disposed.

5. The convertible top arrangement according to claim 1, wherein the environment sensor has at least one field of view, which changes as a function of the position of the convertible top.

6. A convertible arrangement, comprising:
a displaceable convertible top which is displaceable between a covering position, in which it spans a vehicle interior, and a storage position, in which the vehicle interior is exposed at the top and the convertible top is received by a convertible top storage space, and a convertible top box lid,
which is displaceable between a closed position closing the convertible top storage space and an open position exposing the convertible top storage space at the top,
wherein at least one environment sensor, which is disposed at the convertible top box lid and/or at least one environment sensor accessory, which is disposed at the convertible top box lid.

7. The convertible arrangement according to claim 6, wherein the environment sensor has a field of view oriented towards the vehicle rear when the convertible top box lid is in the closed position.

8. The convertible arrangement according to claim 6, wherein a rear window of the convertible top is located in the field of view of the environment sensor when the convertible top is in the covering position.

9. The convertible arrangement according to claim 6, wherein a deploying bracket of the convertible top or a roof shell of the convertible top rests on the convertible top box lid when the convertible top is in the covering position and a sensor see-through area, which borders on the vehicle environment independently of the covering position, is formed at the convertible top box lid.

10. The convertible arrangement according to claim 6, wherein the convertible top box lid has a dome, which receives the environment sensor and/or the environment sensor accessory.

11. The convertible arrangement according to claim 4, wherein the lowerable bow is a lowerable rear bow.
